(19) United States
(12) Patent Application Publication
(10) Pub. No.: US 2012/0166247 A1
(43) Pub. Date: Jun. 28, 2012

(54) METHOD AND SYSTEM FOR MODELLING SUPPLY CHAIN NETWORK

(75) Inventors: Mengru (Arthur) Tu, Taipei City (TW); Jane Chen, Hsinchu City (TW); Chen-Jyh Fan, Hsinchu County (TW)

(73) Assignee: INDUSTRIAL TECHNOLOGY RESEARCH INSTITUTE, Hsinchu (TW)

(21) Appl. No.: 13/154,415

(22) Filed: Jun. 6, 2011

(30) Foreign Application Priority Data
Dec. 22, 2010 (TW) 99145270

(51) Int. Cl. G06Q 10/00

(52) U.S. Cl. 705/7.27; 705/348

(57) ABSTRACT

A method and a system for modelling a supply chain network are provided. The present method includes defining a plurality of pilot elements, wherein each of the pilot elements includes a plurality of supply chain components. The present method also includes receiving a plurality of user inputs and generating and displaying a supply chain process according to the user inputs, wherein the supply chain process is constructed with the supply chain components of the pilot elements. The present method further includes translating the supply chain process into a supply chain network model and verifying the supply chain network model. Thereby, the present method and system can effectively model and establish a supply chain network.

### CROSS-REFERENCE TO RELATED APPLICATION

This application claims the priority benefit of Taiwan application serial no. 99145270, filed Dec. 22, 2010. The entirety of the above-mentioned patent application is hereby incorporated by reference herein and made a part of this specification.

### TECHNICAL FIELD

The disclosure relates to a method and a system for modelling a supply chain network.

### BACKGROUND

Electronic tags based on the radio-frequency identification (RFID) technology are broadly used. Existing electronic tags are usually compliant with related standards created by the EPCglobal organization, such as the electronic product code (EPC) and the EPCglobal network architecture. Information of products with electronic tags can be accessed through the EPCglobal network architecture, and former information of the products with the electronic tags can be obtained by upstream and downstream enterprises of a supply chain through an EPCglobal network. Such a system architecture is also referred to as the “Internet of things”. Today's most common electronic tag applications include animal chips, auto security chips, security control, parking lot control, production line automation, and materials management, etc. In the retail industry, electronic tags can assist in inventory control, reduce supply chain cost, reduce control and management cost, and increase the flexibility in commodity stocks dispatching, and electronic tags can also be used for tracking product distribution from manufacturers to wholesalers along with the “Internet of things” technology.

For example, when electronic tags are attached to products of upstream and downstream enterprises of a supply chain and electronic tag reader/writers are deployed at important nodes of the upstream and downstream enterprises, the upstream and downstream enterprises of the supply chain can track the products with the electronic tags, share supply chain information with each other, and automatically balance between supply and demand in real time.

Presently, we can search product records or pedigree through an EPCglobal network based on aforementioned the “Internet of things” architecture. However, an EPCgloabl alone cannot allow supply chain partners to share the supply and demand information in real time. To be specific, a “Internet of things” with a real-time supply and demand information sharing function can effectively resolve the problem of information asymmetry in a supply chain, so as to improve the quality of supply chain information, reduce the bull whip effect, and improve the efficiency of collaborative planning, forecasting, and replenishment (CPFR). Accordingly, the order fulfillment rate of an enterprise can be effectively improved, and the inventory level of the enterprise on a supply chain can be effectively reduced. Besides, such an architecture can be served as a reference model for developing next-generation “Internet of things” systems. An “Internet of things” requires upstream and downstream enterprises to be connected through a process. Thereby, how to design a system design platform so as to provide a consistent collaborative design interface for developing “Internet of things” systems has become one of the major subjects in the industry.

### SUMMARY

A method and a system for modelling a supply chain network are introduced herein, wherein a consistent collaborative design interface is provided for developing a supply chain network system.

The disclosure provides a method for modelling a supply chain network. The present method includes defining a plurality of pilot elements, wherein each of the pilot elements includes a plurality of supply chain components. The present method also includes receiving a plurality of user inputs and generating and displaying a supply chain process according to the user inputs, wherein the supply chain process is constructed with the supply chain components of the pilot elements. The present method further includes translating the supply chain process into a supply chain network model and verifying the supply chain network model.

The disclosure provides a system for modeling a supply chain network. The present system includes a supply chain network object edit and management module, a supply chain process edit and management module, a supply chain network translation and edit module, and a supply chain network model verification module. The supply chain network object edit and management module defines a plurality of pilot elements, wherein each of the pilot elements includes a plurality of supply chain components. The supply chain process edit and management module receives a plurality of user inputs and generates and displays a supply chain process according to the user inputs, wherein the supply chain process is constructed with the supply chain components of the pilot elements. The supply chain network translation and edit module translates the supply chain process and generates a supply chain network model corresponding to the supply chain process. The supply chain network model verification module verifies the supply chain network model.

As described above, exemplary embodiments of the disclosure provide a method and a system for modeling a supply chain network, wherein the supply chain network can be effectively modelled and established.

Several exemplary embodiments accompanied with figures are described in detail below to further describe the disclosure in details.

### BRIEF DESCRIPTION OF THE DRAWINGS

The accompanying drawings are included to provide further understanding, and are incorporated in and constitute a part of this specification. The drawings illustrate exemplary embodiments and, together with the description, serve to explain the principles of the disclosure.

FIG. 1 illustrates a supply chain network modelling system according to an exemplary embodiment of the disclosure.

FIG. 2 illustrates an example of a supply chain network ontology according to an exemplary embodiment of the disclosure.

FIG. 3 illustrates an example of an edit interface displayed in an edit and display interface according to an exemplary embodiment of the disclosure.

FIG. 4 illustrates an example of event parameters according to an exemplary embodiment of the disclosure.

FIG. 5 illustrates an example of an electronic product code information services (EPCIS) event template according to an exemplary embodiment of the disclosure.

FIG. 6 illustrates an example of accessing an EPCIS event template according to an exemplary embodiment of the disclosure.

FIGS. 7A-7G are diagrams illustrating an example of a process-to-Petri net conversion template according to an exemplary embodiment of the disclosure.

FIG. 8 is a diagram of identification tokens according to an exemplary embodiment of the disclosure.

FIGS. 9A-9C are diagrams illustrating an example of translating a supply chain process into a Petri net-based supply chain network model according to an exemplary embodiment of the disclosure.

FIG. 10 is a diagram of a Petri net-based supply chain network model displayed in an edit and display interface according to an exemplary embodiment of the disclosure.

FIG. 11 illustrates an example of a supply chain network model according to an exemplary embodiment of the disclosure.

FIGS. 12A-12H illustrate an example of verifying the supply chain network model in FIG. 11.

FIG. 13 is a flowchart of a supply chain network modelling method according to an exemplary embodiment of the disclosure.

FIG. 14 is a flowchart of translating a supply chain process into a Petri net-based supply chain network model according to an exemplary embodiment of the disclosure.

FIG. 15 is a flowchart of a deadlock diagnosis procedure according to an exemplary embodiment of the disclosure.

### DETAILED DESCRIPTION OF DISCLOSED EMBODIMENTS

In a supply chain network modelling method provided by the disclosure, a plurality of pilot elements containing a plurality of supply chain components are pre-defined, and a supply chain process is generated and displayed by using the supply chain components according to user inputs. Additionally, in the supply chain network modelling method provided by the disclosure, the supply chain process is translated into a corresponding supply chain network model, and the supply chain network model is verified. Accordingly, users on a supply chain (for example, suppliers, manufacturers, and retailers) can develop a supply chain system and ensure the accuracy of the supply chain network by using a consistent collaborative design interface. Below, an exemplary embodiment will be described with reference to accompanying drawings, so as to make advantages of the technique provided by the disclosure more apparent.

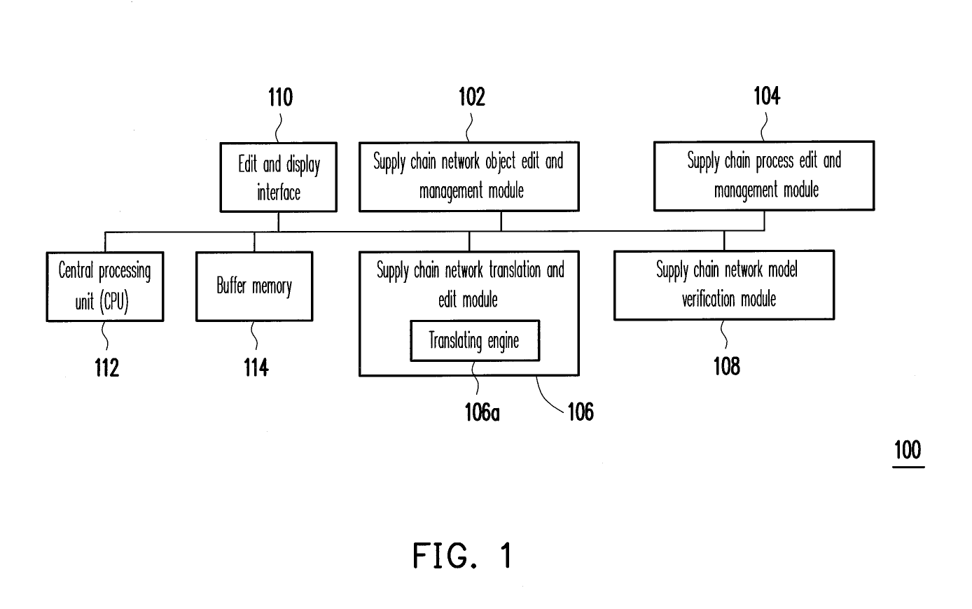

FIG. 1 illustrates a supply chain network modelling system according to an exemplary embodiment of the disclosure.

Referring to FIG. 1, the supply chain network modelling system 100 includes a supply chain network object edit and management module 102, a supply chain process edit and management module 104, a supply chain network translation and edit module 106, a supply chain network model verification module 108, and an edit and display interface 110.

The supply chain network object edit and management module 102 defines the pilot elements. In the present exemplary embodiment, the supply chain network object edit and management module 102 constructs an ontology for a supply chain network and defines the pilot elements and the supply chain components corresponding to each pilot element in the ontology.

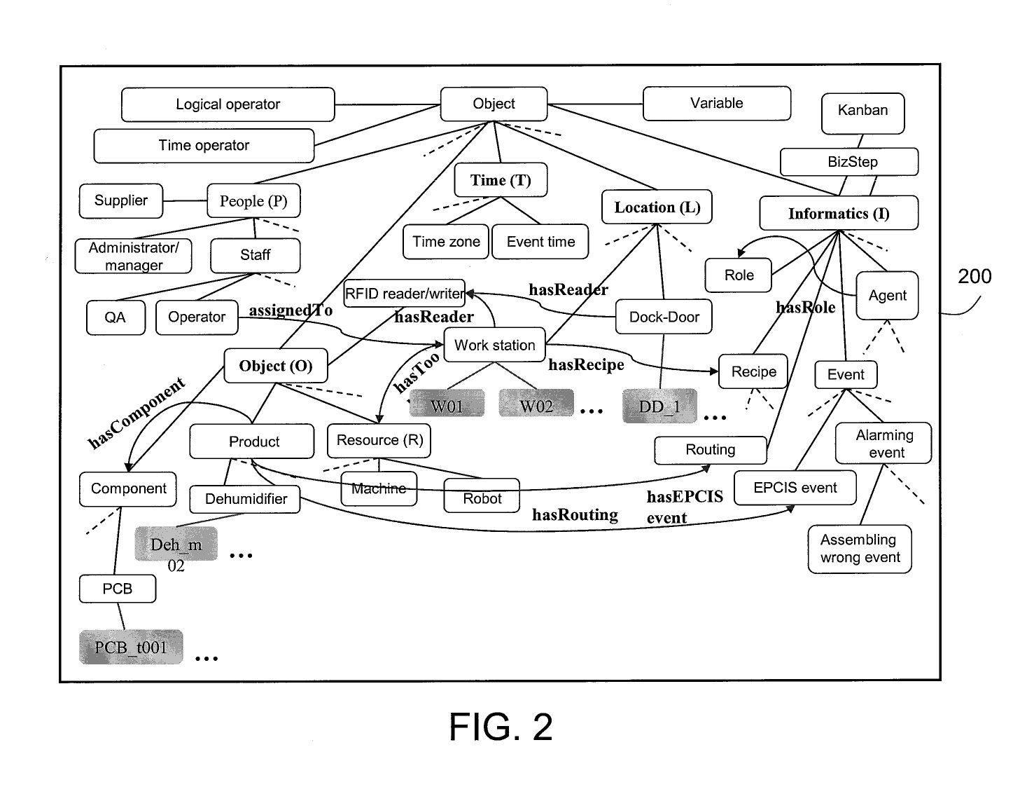

FIG. 2 illustrates an example of a supply chain network ontology according to an exemplary embodiment of the disclosure.

Referring to FIG. 2, in the supply chain network ontology 200, the supply chain network object edit and management module 102 defines 5 types of pilot elements, which are: people (P) pilot elements, supply chain network information (I) pilot elements, supply chain network location (L) pilot elements, physical object (O) pilot elements, and supply chain network event time (T) pilot elements. The P pilot elements include those supply chain components in the supply chain network that are categorized as people. For example, juridical person components represent enterprises in a supply chain network, and natural person components represent employees (for example, managers and operators) inside the enterprises. The I pilot elements include supply chain network information components, such as business step (BizStep) information components, event information components, and kanban information components. The L pilot elements include supply chain network location components. The O pilot elements include physical object components related to the supply chain network. The T pilot elements include supply chain network event time components. The method for constructing the ontology is well known to those skilled in the art therefore will not be described herein.

The supply chain process edit and management module 104 receives a plurality of user inputs and generates and displays a supply chain process according to the user inputs.

To be specific, a user inputs (for example, place or drag) objects derived from aforementioned supply chain components through the edit and display interface 110, so as to edit the supply chain process. Meanwhile, the supply chain process edit and management module 104 instantly generates and displays the supply chain process according to such user inputs.

The major steps for editing the supply chain process include:
1. defining supply chain (enterprise) boundaries;
2. configuring a supply chain object;
   2-1. defining a BizStep object;
   2-2. configuring the related object;
3. describing a material flow and an information flow of the supply chain;
4. defining a radio-frequency identification (RFID) access point;
5. defining a tag filter pattern or an ontology rule in the RFID access point;
6. defining a supply chain event (a customized event or a standard electronic product code information services (EPCIS) event).

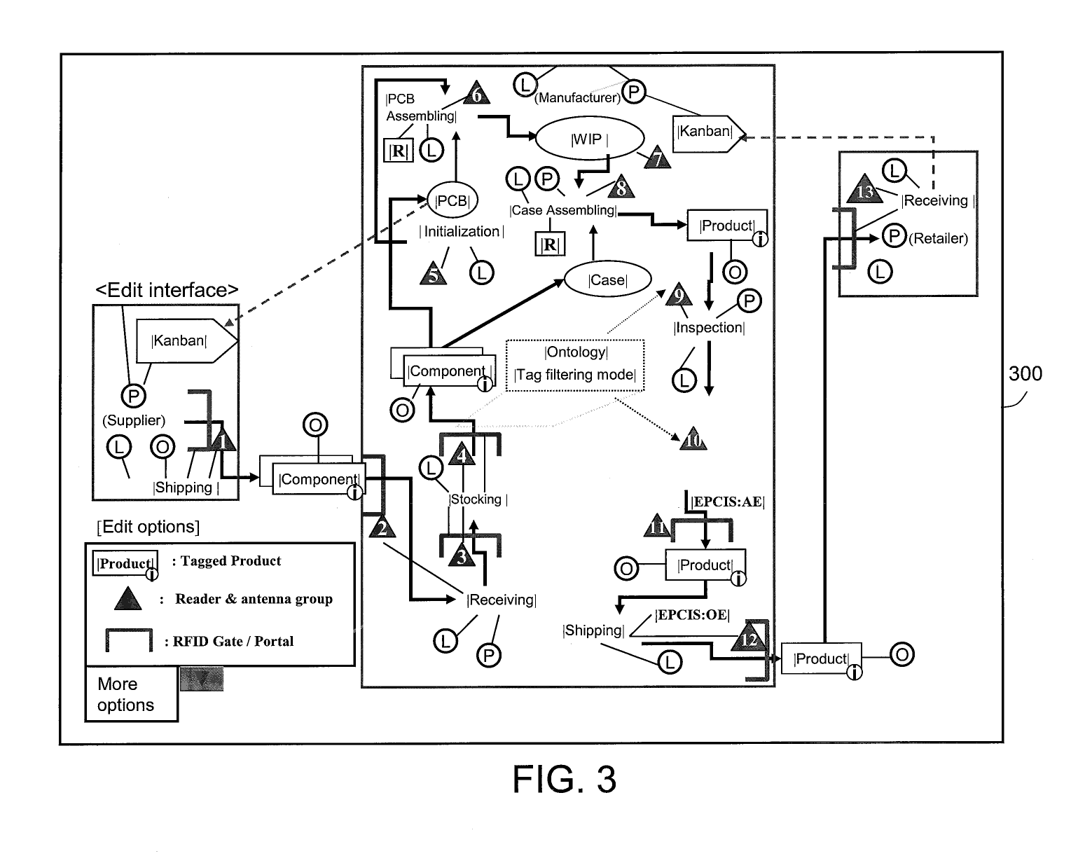

FIG. 3 illustrates an example of an edit interface displayed in the edit and display interface 110 according to an exemplary embodiment of the disclosure.

Referring to FIG. 3, in an edit interface 300, the editing of the supply chain process can be divided into a supply chain boundary definition phase, a supply chain object configuration phase, a supply chain RFID access point configuration phase, a supply chain material flow and information flow description phase, and a supply chain event definition phase. Below, each of these 5 phases will be respectively explained.

### (1) Supply Chain Boundary Definition Phase

The supply chain process edit and management module 104 defines the boundaries of the supply chain process according to user inputs. For example, as shown in FIG. 3, a user divides the supply chain process into a supplier portion, a manufacturer portion, and a retailer portion by using boundary frames. Thus, planning personnel from different enterprises can develop a supply chain system by using a consistent collaborative design interface.

### (2) Supply Chain Object Configuration Phase

The supply chain process edit and management module 104 configures corresponding objects in the supply chain process according to user inputs (for example, place and drag the objects). For example, the user can configures objects representing managers or operators (the circles marked with ‘P’ in FIG. 3), objects representing locations (the circles marked with ‘L’ in FIG. 3), objects representing physical objects (for example, products or semi-finished products) (circles marked with ‘O’ in FIG. 3), objects representing BizSteps (for example, delivery, assembly, and packaging activities) (circles marked with ‘∥’ in FIG. 3), or objects representing kanban (the object marked with ‘|Kanban Boards|’ in FIG. 3) in the supply chain process.

### (3) Supply Chain Material Flow and Information Flow Description Phase

The supply chain process edit and management module 104 generates a material flow (as indicated by solid arrows in FIG. 3) and an information flow (as indicated by dotted arrows in FIG. 3) of the supply chain process according to the user inputs. To be specific, after configuring the objects related to the supply chain, the user describes the material flow and the information flow in the supply chain by using solid lines and dotted lines connecting these objects.

During the process of configuring the objects in the supply chain process through the edit and display interface 110, when the user configures the BizStep information objects, the supply chain process edit and management module 104 identifies next step pointer (NS) of each BizStep information object. To be specific, the supply chain process is composed of a plurality of BizSteps. Thus, the step following each BizStep has to be identified to construct the entire supply chain process completely.

In addition, in an exemplary embodiment of the disclosure, when the user configures an oval object, the supply chain process edit and management module 104 identifies the oval object as a location place, such as a buffer. When the user configures a rectangular object, the supply chain process edit and management module 104 identifies the rectangular object as a status place, such as the delivery state of a part or a product. When the user configures a square object, the supply chain process edit and management module 104 identifies the square object as a resource place, such as a machine or a robot. When the user configures a pentagonal object, the supply chain process edit and management module 104 identifies the pentagonal object as a kanban place.

### (4) Supply Chain RFID Access Point Configuration Phase

The supply chain process edit and management module 104 identifies RFID access points (i.e., the triangular objects and n-shaped objects in FIG. 3) in the supply chain. To be specific, when the user configures the triangular objects and n-shaped objects, the supply chain process edit and management module 104 sets a tag filter pattern or an ontology rule in each of the RFID access points. Namely, different RFID access points have different tag reading conditions. For example, only the RFID tag on the case or a specific product tag inside the case is read. Thus, different tag data filtering modes have to be configured at different access points regarding different tag reading conditions. To be more specific, the filtered RFID information can be converted into elements defined by the ontology rules, and the activity rules of the ontology rule elements are defined. In particular, the ontology rules may also be considered as business logic of enterprise activities.

### (5) Supply Chain Event Definition Phase

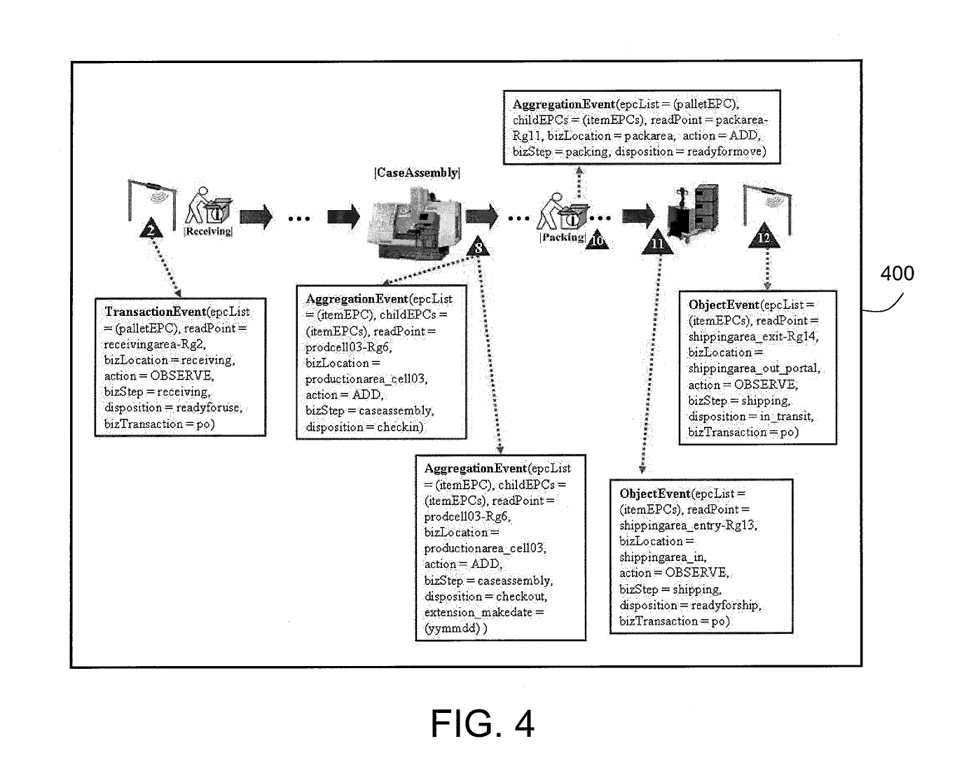

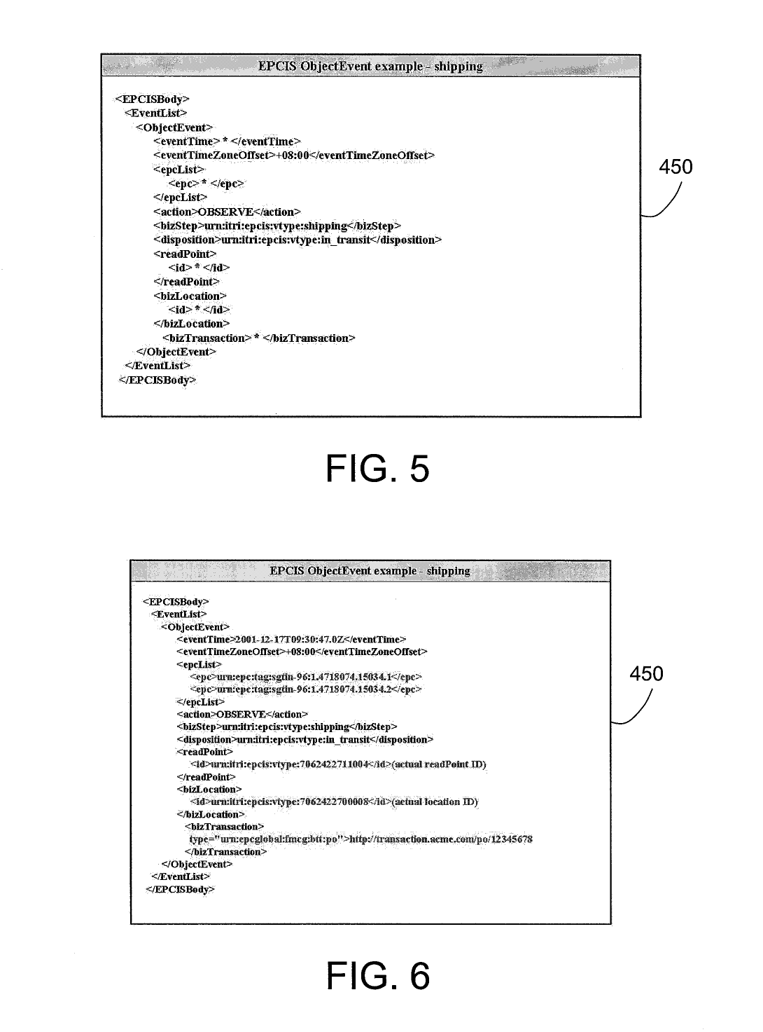

The supply chain process edit and management module 104 identifies supply chain event objects (the objects marked with ‘|EPCIS:|’ in FIG. 3) in the supply chain process. To be specific, when the user configures the supply chain event objects, the supply chain process edit and management module 104 generates an EPCIS event parameter (as the event parameter edit interface 400 in FIG. 4) and an EPCIS event template (as the event template 450 in FIG. 5) for each of the supply chain event objects. It should be mentioned that the formats of the event parameters and the event templates are defined according to the Core Business Vocabulary (CBV) constructed by the EPCglobal organization. Thus, the user can access data in a template through the corresponding RFID access point by simply filling corresponding data into the corresponding fields (as shown in FIG. 6).

Referring to FIG. 1 again, the supply chain network translation and edit module 106 translates the supply chain process generated by the supply chain process edit and management module 104 into a corresponding supply chain network model.

For example, in the present exemplary embodiment, the supply chain network translation and edit module 106 translates the supply chain process generated by the supply chain process edit and management module 104 into a Petri net-based supply chain network model. However, the disclosure is not limited thereto, and any type of supply chain network model can be applied in the disclosure. Particularly, in the present exemplary embodiment, the supply chain network translation and edit module 106 has a process-to-Petri net conversion template and a translating engine 106a. The translating engine 106a is configured to convert the BizStep information objects in the supply chain process into corresponding Petri net structures by using the process-to-Petri net conversion template.

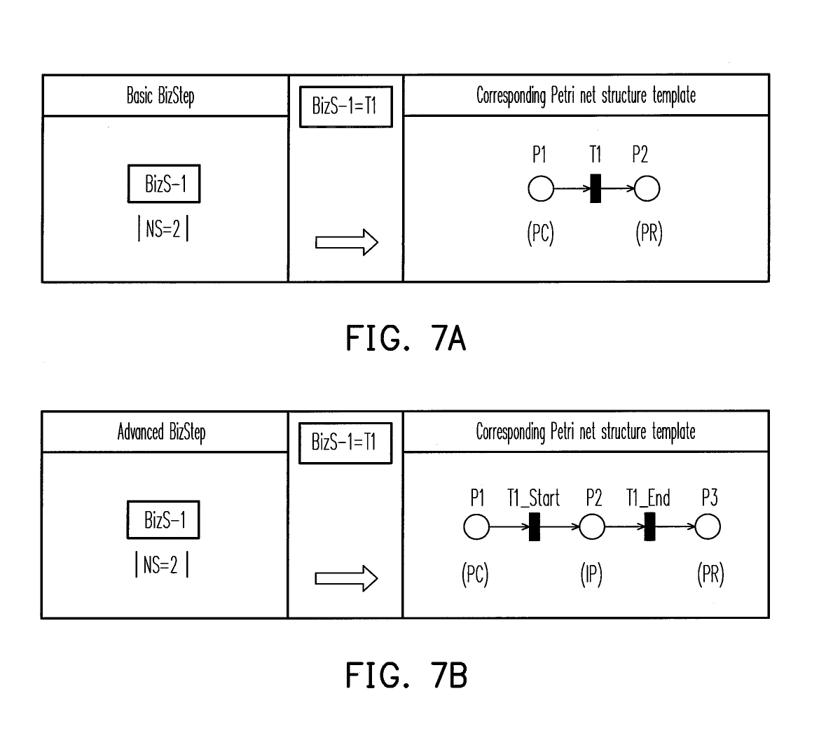

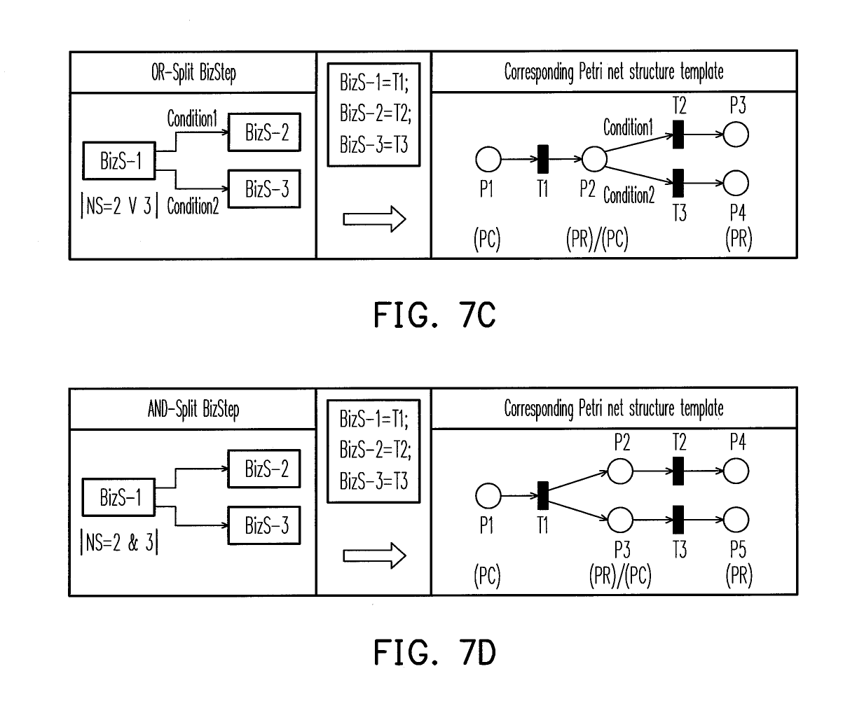

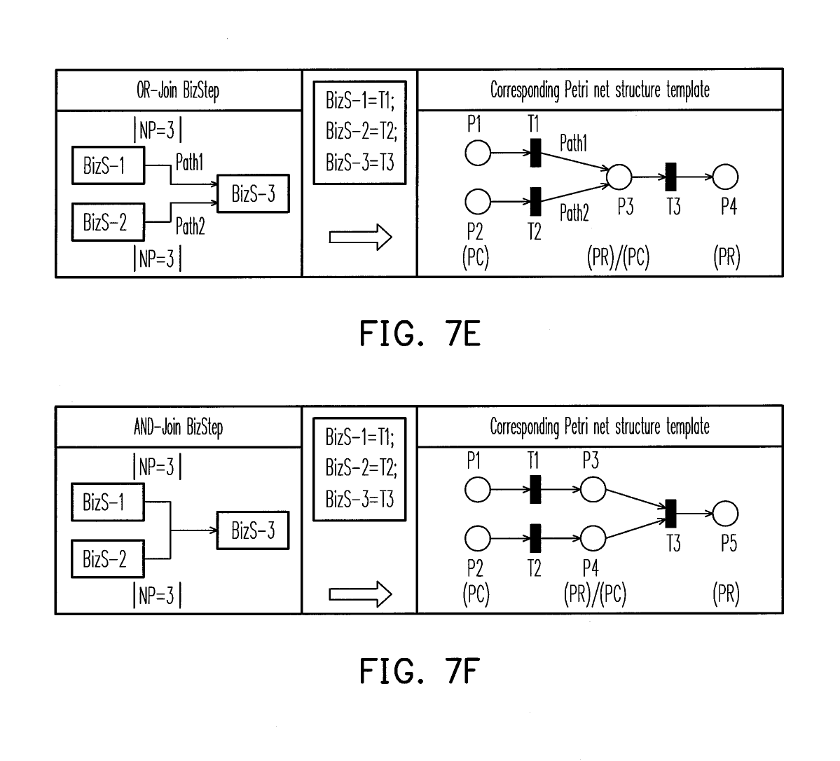

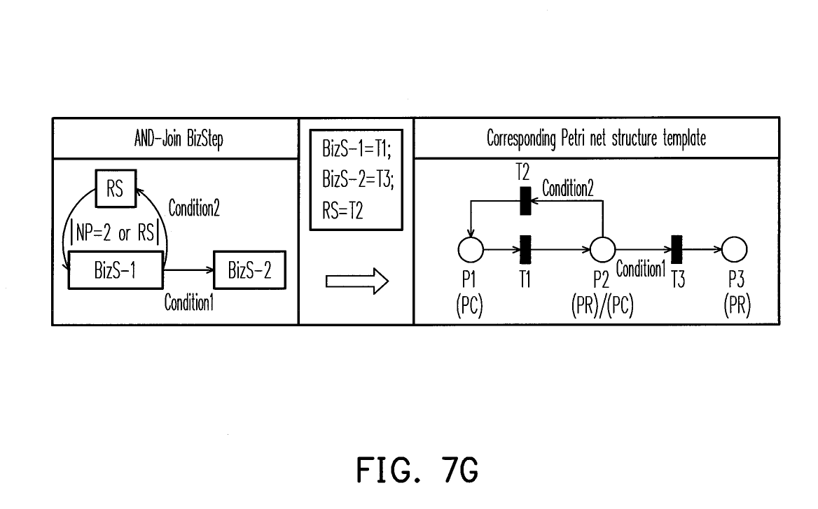

FIGS. 7A-7G are diagrams illustrating an example of a process-to-Petri net conversion template according to an exemplary embodiment of the disclosure, wherein the process-to-Petri net conversion template includes a basic BizStep information object Petri net template (as shown in FIG. 7A), an advanced BizStep information object Petri net template (as shown in FIG. 7B), an OR-split BizStep information object Petri net template (as shown in FIG. 7C), an AND-split BizStep information object Petri net template (as shown in FIG. 7D), an OR-join BizStep information object Petri net template (as shown in FIG. 7E), an AND-join BizStep information object Petri net template (as shown in FIG. 7F), and a loop BizStep information object Petri net template (as shown in FIG. 7G).

Referring to FIG. 7A, the basic BizSteps in the supply chain process are converted into Petri net structures with a pre-condition (PC) place, an activity, and a processing result (PR) place. For example, a basic BizStep marked as an activity T1 is converted into a Petri net structure with a PC place P1, an activity T1, and a PR place P2.

Referring to FIG. 7B, the advanced BizSteps in the supply chain process are converted into Petri net structures with a PC place, a start activity, an in-process (IP) place, an end activity, and a PR place. For example, an advanced BizStep marked as an activity T1 is converted into a Petri net structure with a PC place P1, a start activity T1_Start, an IP place P2, an end activity T_End, and a PR place P3.

Referring to FIG. 7C, the Petri net structure converted from an OR-split BizStep in the supply chain process means that one of two following steps is executed according to a condition after a previous step is finished. For example, assuming that the activities T2 and T3 are after the activity T1, in the OR-split BizStep template, after the activity T1 is finished, the activity T2 is executed if a condition 1 is met and the activity T3 is executed if a condition 2 is met.

Referring to FIG. 7D, the Petri net structure converted from an AND-split BizStep in the supply chain process means that two following steps are both executed after a previous step is finished. For example, assuming that the activities T2 and T3 are after the activity T1, in the AND-split BizStep template, the activity T2 and the activity T3 are both executed after the activity T1 is finished.

Referring to FIG. 7E, the Petri net structure converted from an OR-join BizStep in the supply chain process means that a following step is executed after one of two previous steps is finished. For example, assuming that the activity T3 is after the activities T1 and T2, in the OR-join BizStep template, the following activity T3 is executed after the activity T1 or the activity T2 is finished.

Referring to FIG. 7F, the Petri net structure converted from an AND-join BizStep in the supply chain process means that a following step is executed after two previous steps are both finished. For example, assuming that the activity T3 is after the activities T1 and T2, in the AND-join BizStep template, the following activity T3 is executed after the activities T1 and T2 are both finished.

Referring to FIG. 7G, the Petri net structure converted from a loop BizStep in the supply chain process means that a specific step is repeatedly executed under a specific condition and a following step is executed only when another condition is met. For example, assuming that the activity T3 is after the activity T1 and the activity T2 is repeatedly executed, in the loop BizStep template, after the activity T1 is finished, the activity T2 is repeatedly executed when a condition 1 is met, and the activity T3 is executed only when a condition 2 is met.

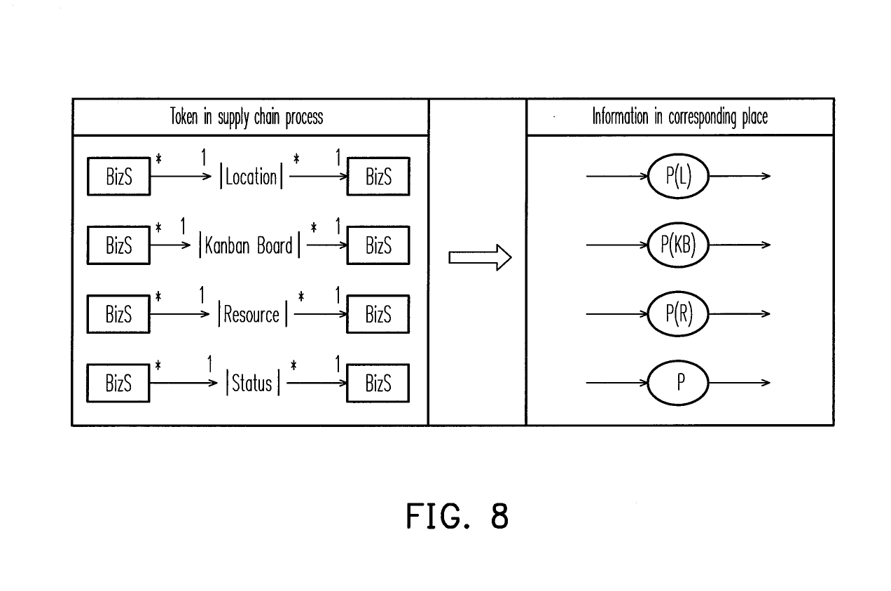

Additionally, in the present exemplary embodiment, the supply chain network translation and edit module 106 identifies a token as different information according to the place of the token. For example, the supply chain network translation and edit module 106 identifies a token in the location place of the supply chain process as a product, a product assembly, or a product part. Besides, the supply chain network translation and edit module 106 identifies a token in the resource place of the supply chain process as a machine or a robot. Moreover, the supply chain network translation and edit module 106 identifies a token in the status place of the supply chain process as a processing status of a tagged object (as shown in FIG. 8).

In the present exemplary embodiment, the translating engine 106a categorizes and converts the BizStep information objects in the supply chain process into a plurality of subnet structures by using the process-to-Petri net conversion template. In addition, the translating engine 106a outputs the subnet structures as a Petri net-based supply chain network model.

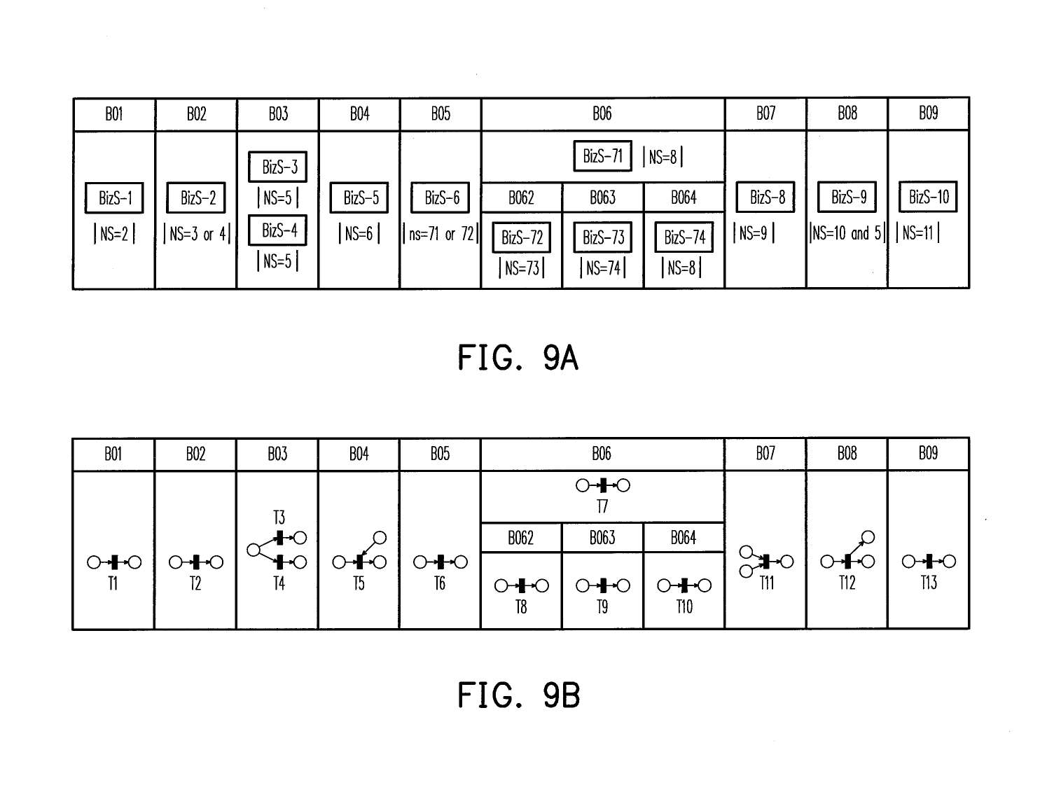

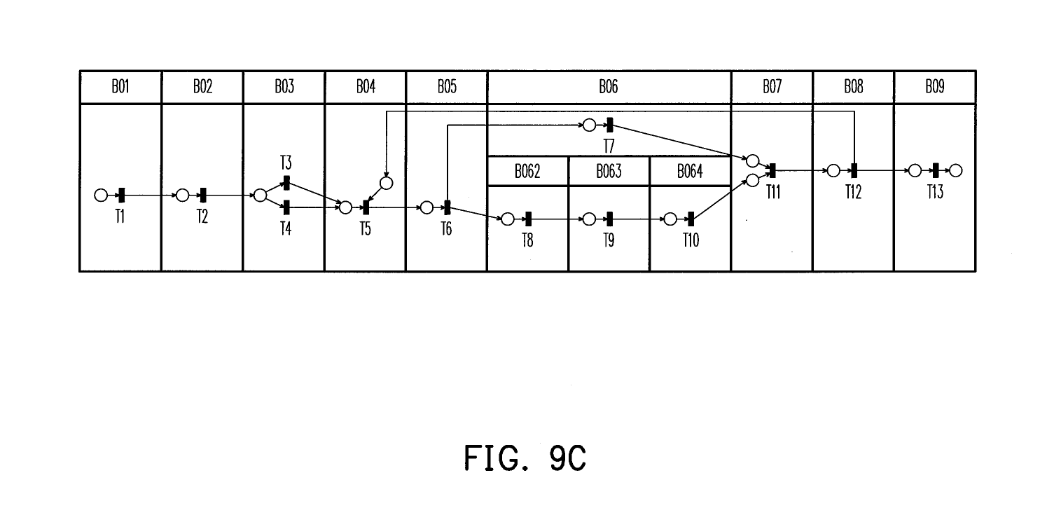

FIGS. 9A-9C are diagrams illustrating an example of translating a supply chain process into a Petri net-based supply chain network model according to an exemplary embodiment of the disclosure.

Referring to FIG. 9A, the translating engine 106a sequentially arranges the BizStep information objects in the supply chain process into a plurality of functional blocks and connects these functional blocks according to the NS of the BizStep information objects.

Then, referring to FIG. 9B, the translating engine 106a converts the functional blocks into corresponding subnet structures according to the process-to-Petri net conversion template. To be specific, the translating engine 106a converts the functional blocks in the supply chain process into corresponding Petri net structures according to the Petri net structure corresponding to each type of BizSteps.

Next, referring to FIG. 9C, the translating engine 106a merges the corresponding input places and output places in the subnet structures to connect the subnet structures and outputs the connected subnet structures as a corresponding Petri net-based supply chain network model. To be specific, the translating engine 106a analyzes the input places and output places in the subnet structures and merges the output place of a previous step with the input place of a next step, so as to connect all the subnet structures and generate the Petri net-based supply chain network model.

In the present exemplary embodiment, the supply chain network translation and edit module 106 displays the supply chain network model generated by the translating engine 106a in the edit and display interface 110 as a circle.

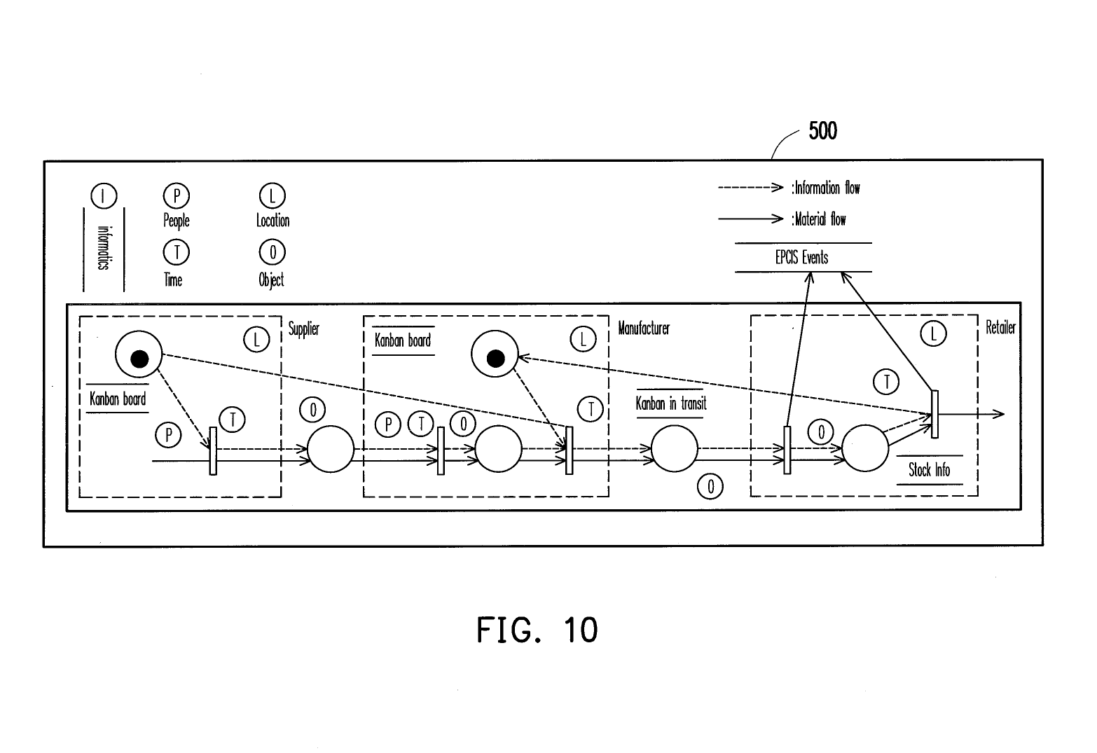

FIG. 10 is a diagram of a Petri net-based supply chain network model displayed in an edit and display interface according to an exemplary embodiment of the disclosure.

Referring to FIG. 10, a user can view a supply chain network model 500 in the edit and display interface 110. In particular, the user can tune the supply chain network model 500 by input a user tuning input in the edit and display interface 110, and the supply chain network translation and edit module 106 adjusts the supply chain network model 500 according to the user tuning input. Namely, if the user detects an error in the supply chain network model 500, the user can adjust the supply chain network model 500 through the edit and display interface 110, and the supply chain network translation and edit module 106 can identify and process the portion adjusted by the user.

Referring to FIG. 1 again, the supply chain network model verification module 108 is configured to verify the supply chain network model. To be specific, the supply chain network model verification module 108 generates related mathematical matrixes according to the Petri net-based supply chain network model generated by the supply chain network translation and edit module 106, and performs a deadlock diagnosis procedure on the supply chain network model to verify the accuracy thereof based on a network state equation based on the Petri net principle. Herein the deadlock diagnosis procedure is to determine whether any state of the supply chain network model does not trigger any activity through the related mathematical matrixes for constructing and calculating the supply chain network model. If there is such a state that does not trigger any activity, it is determined that the supply chain network model has a deadlock. Otherwise, it is determined that the supply chain network model has no deadlock.

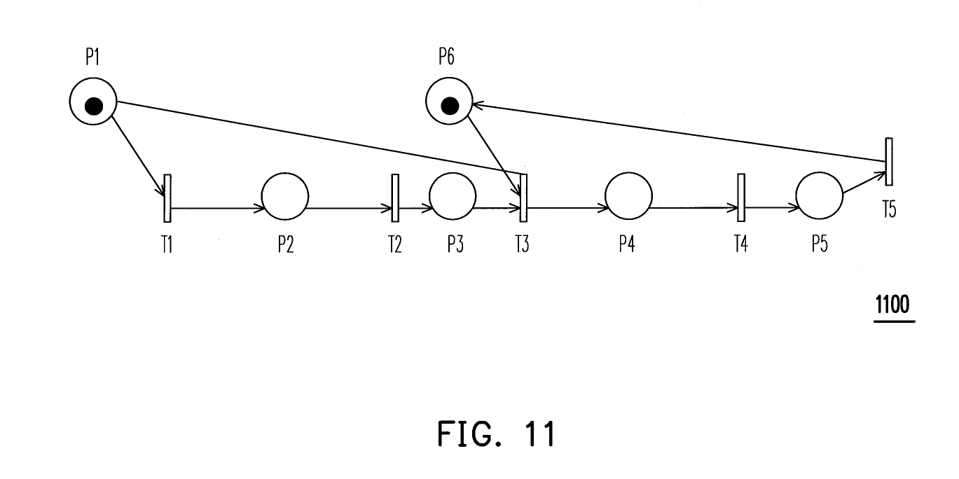

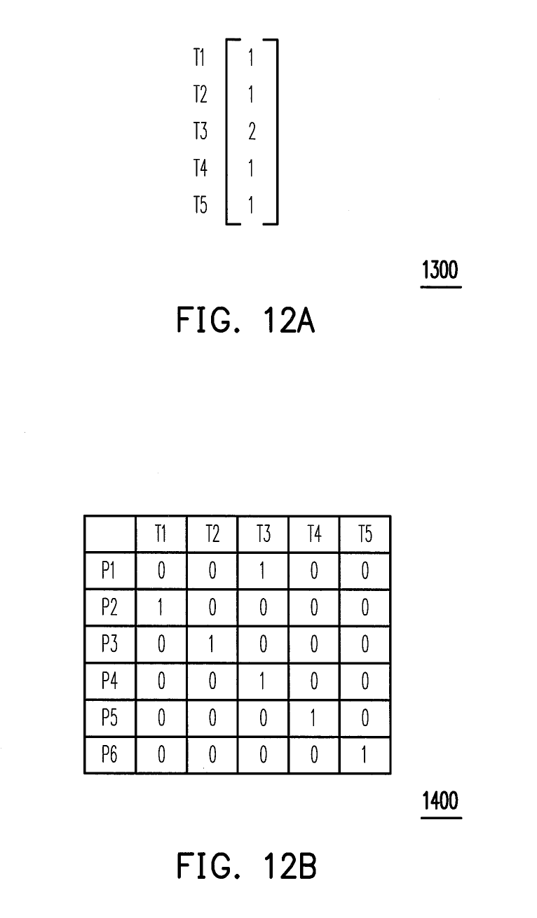

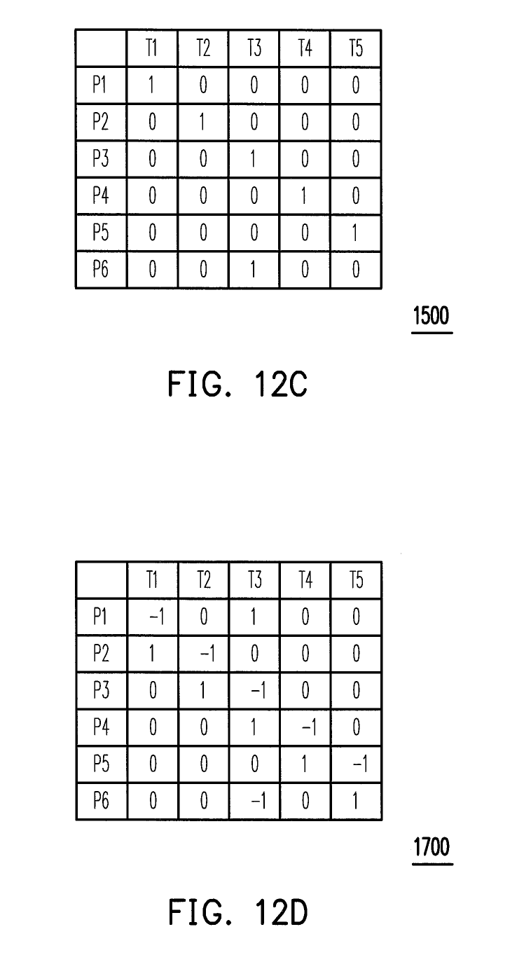

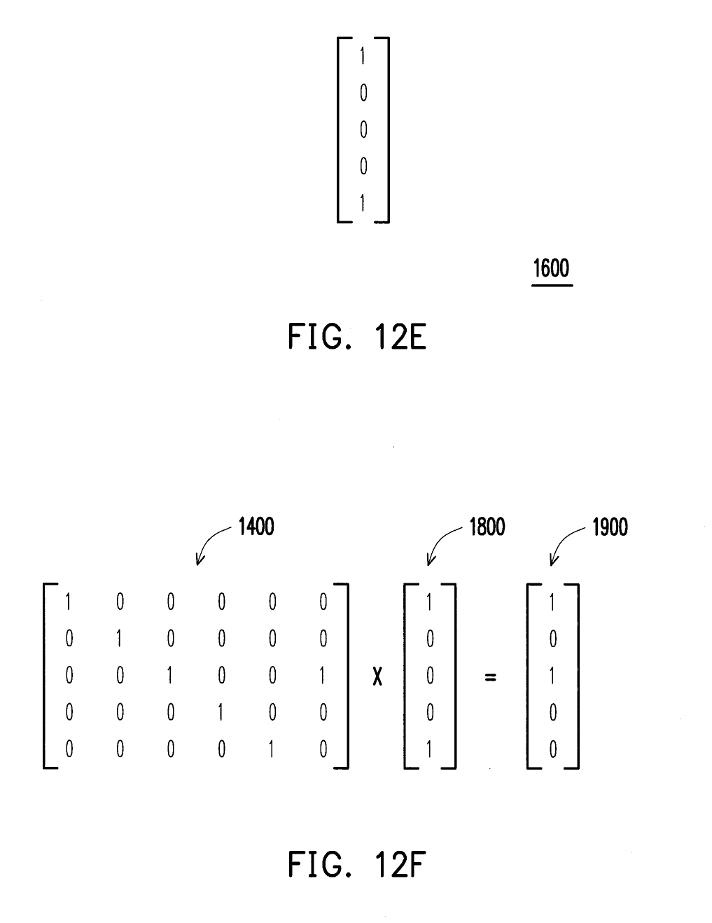

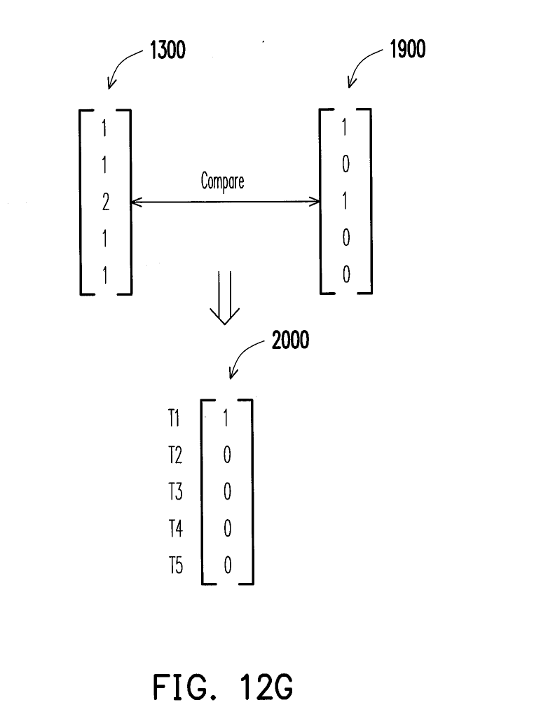

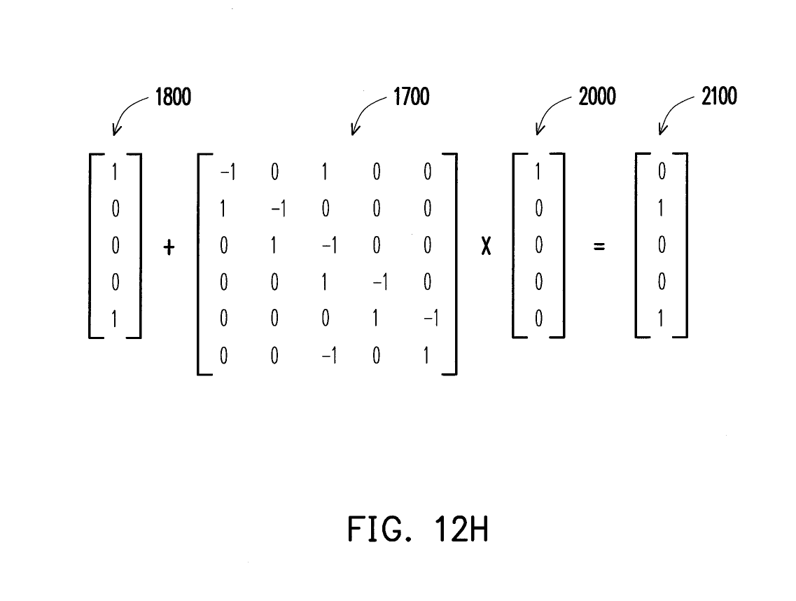

FIG. 11 illustrates an example of a supply chain network model according to an exemplary embodiment of the disclosure, and FIGS. 12A-12H illustrate an example of verifying the supply chain network model in FIG. 11.

Referring to FIG. 11 and FIGS. 12A-12E, before the verification starts, the supply chain network model verification module 108 initially obtains a drivable state vector 1300 (as shown in FIG. 12A), an output matrix 1400 (as shown in FIG. 12B), and an input matrix 1500 (as shown in FIG. 12C) from the supply chain network model 1100 and generates a incidence matrix 1700 (as shown in FIG. 12D).

The drivable state vector 1300 shows the number of places for triggering each activity (i.e., each of the activities T1-T5) in the supply chain network model 1100. As shown in FIG. 12A, the activity T1 is triggered by the place P1, the activity T2 is triggered by the place P2, the activity T3 is triggered by the place P3 and the place P6, the activity T4 is triggered by the place P4, and the activity T5 is triggered by the place P5. Thus, the drivable state vector 1300 corresponding to the supply chain network model 1100 is composed of the numbers (i.e., 1, 1, 2, 1, and 1) of places that can trigger the activities T1-T5.

The output matrix 1400 shows the output place of each activity, wherein if a specific place is the output place of a specific activity, the corresponding value in the output matrix 1400 is set to 1, and if the specific place is not the output place of the specific activity, the corresponding value in the output matrix 1400 is set to 0.

The input matrix 1500 shows the input place of each activity, wherein if a specific place is the input place of a specific activity, the corresponding value in the input matrix 1500 is set to 1, and if the specific place is not the input place of the specific activity, the corresponding value in the input matrix 1500 is set to 0.

The incidence matrix 1700 is generated by deducting the input matrix 1500 from the output matrix 1400 (as expressed by following expression (1)).

A=D⁺−D⁻ (1)

In foregoing expression (1), A represents the incidence matrix, D⁺ represents the output matrix, and D⁻ represents the input matrix.

In addition, during the initialization process, the supply chain network model verification module 108 establishes a marking table and a temporary marking table to record marking vectors during the activity process. Besides, the supply chain network model verification module 108 sets an initial marking vector 1600 (as shown in FIG. 12E) and serves the initial marking vector 1600 as the current marking vector. Herein the initial marking vector is the initial markings of all places.

After the initialization process is completed, the supply chain network model verification module 108 determines whether there is any deadlock in the supply chain network model 1100 through repeated matrix calculations. Below, how the matrix calculations are performed to detect deadlocks will be explained by taking one of the iterations as an example.

Referring to FIG. 12F, when the current marking vector 1800 is the initial marking vector 1600, the supply chain network model verification module 108 multiplies the input matrix 1500 by the current marking vector 1800 to obtain a firing condition vector 1900 (as expressed in following expression (2)). Herein the firing condition vector 1900 shows the current number of places for triggering each activity.

V_{FC}=D⁻×M_{c} (2)

In foregoing expression (2), V_{FC} represents the firing condition vector, and M_{C} represents the current marking vector.

After that, referring to FIG. 12G, the supply chain network model verification module 108 compares the drivable state vector 1300 with the firing condition vector 1900. When the number of places for triggering a specific activity in the firing condition vector 1900 is equal to the number of places for triggering the activity in the drivable state vector 1300, the activity is triggered and the supply chain network model verification module 108 generates a corresponding firing control vector 2000. Herein the firing control vector 2000 shows that a specific activity can be triggered and the value corresponding to the activity in the firing control vector 2000 is set to 1.

It should be mentioned that in a more complicated supply chain network model, multiple activities may be triggered after a specific state. In this case, the supply chain network model verification module 108 generates multiple corresponding firing control vectors.

Next, referring to FIG. 12H, the supply chain network model verification module 108 multiplies the firing control vector 2000 by the incidence matrix 1700 to obtain a vector and adds the current marking vector 1800 to the vector to obtain a new marking vector 2100 (as expressed by following expression (3)).

Mₙ=M_{c}+Auₖ (3)

In foregoing expression (3), Mₙ represents the new marking vector, and uₖ represents the firing control vector.

Thereafter, the supply chain network model verification module 108 records the new marking vector and a triggering BizStep information object corresponding to the new marking vector (i.e., a corresponding activity) into both the marking table and the temporary marking table.

It should be mentioned that if no firing control vector is obtained during the current activity, the supply chain network model verification module 108 marks the current marking vector 1800 as a deadlock marking vector and records the deadlock marking vector and a key BizStep information object corresponding to the deadlock marking vector in the deadlock table. Namely, the key BizStep information object recorded in the deadlock table is a place for triggering a deadlock in the supply chain network model.

In the present exemplary embodiment, the supply chain network model verification module 108 repeatedly obtains a marking vector from the temporary marking table as the current marking vector to performed foregoing calculations. Besides, the verification of the supply chain network model is completed when there is no more marking vector in the temporary marking table.

In the present exemplary embodiment, the supply chain network model verification module 108 verifies the supply chain network model generated by the supply chain network translation and edit module 106 through foregoing deadlock diagnosis procedure and determines whether any deadlock place appears in the supply chain network model. In particular, when a deadlock place appears in the supply chain network model, the supply chain network model verification module 108 highlights (for example, indicates) the deadlock place in the supply chain network model displayed in the edit and display interface 110.

In an exemplary embodiment of the disclosure, the supply chain network object edit and management module 102, the supply chain process edit and management module 104, the supply chain network translation and edit module 106, the supply chain network model verification module 108, and the edit and display interface 110 are implemented as software programs. To be specific, the supply chain network modelling system 100 further includes a central processing unit (CPU) 112 and a buffer memory 114. Besides, the program codes of the supply chain network object edit and management module 102, the supply chain process edit and management module 104, the supply chain network translation and edit module 106, the supply chain network model verification module 108, and the edit and display interface 110 are loaded into the buffer memory 114 and ran by the CPU 112, so that a supply chain network modelling platform can be provided to the user.

However, it should be understood that the disclosure is not limited to foregoing description, and in another exemplary embodiment of the disclosure, the supply chain network object edit and management module 102, the supply chain process edit and management module 104, the supply chain network translation and edit module 106, the supply chain network model verification module 108, and the edit and display interface 110 may also be implemented as hardware components.

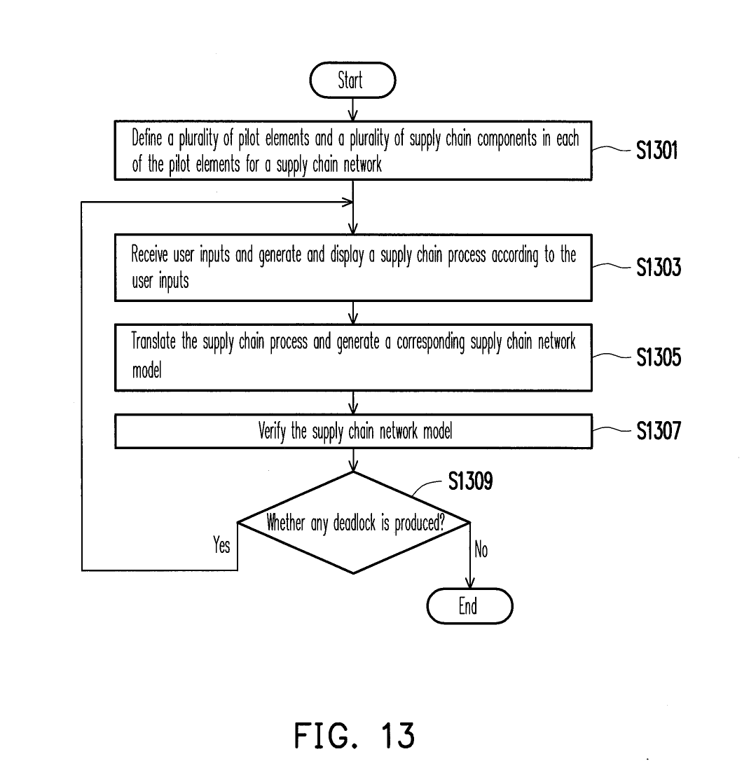

FIG. 13 is a flowchart of a supply chain network modelling method according to an exemplary embodiment of the disclosure.

Referring to FIG. 13, in step S1301, the supply chain network object edit and management module 102 defines a plurality of pilot elements and a plurality of supply chain components in each of the pilot elements for the supply chain network. As described above, the pilot elements and the supply chain components are defined according to a supply chain network ontology.

In step S1303, the supply chain process edit and management module 104 receives user inputs through the edit and display interface 110 and generates and displays a supply chain process according to the user inputs. Herein the supply chain process is generated by using objects derived from the pilot elements and the supply chain components thereof defined in step S1301 (as shown in FIG. 3).

In step S1305, the supply chain network translation and edit module 106 translates the supply chain process and generates a corresponding supply chain network model. As described above, the translating engine 106a of the supply chain network translation and edit module 106 converts the supply chain process into a Petri net-based supply chain network model by using a process-to-Petri net conversion template.

In step S1307, the supply chain network model verification module 108 verifies the supply chain network model. In step S1309, whether any deadlock is produced is determined. If the supply chain network model has deadlocks, the supply chain process is corrected in step S1303. If the supply chain network model has no deadlock, the entire procedure ends here.

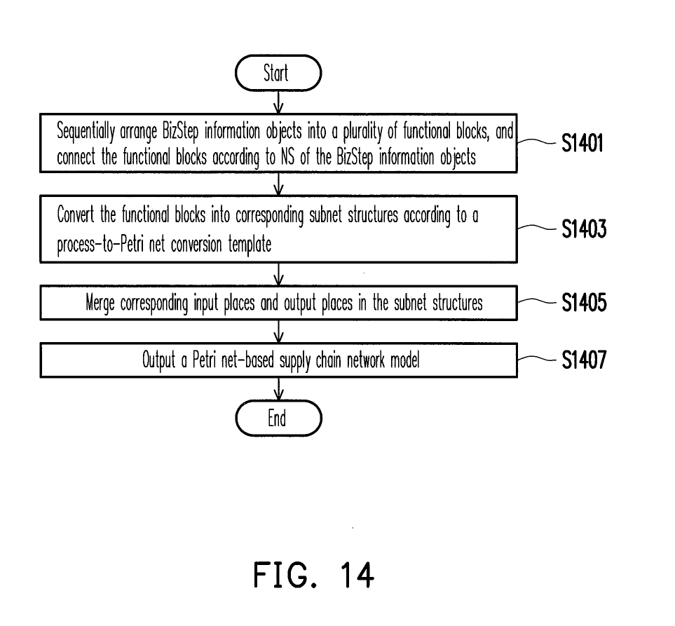

FIG. 14 is a flowchart of translating a supply chain process into a Petri net-based supply chain network model according to an exemplary embodiment of the disclosure.

Referring to FIG. 14, in step S1401, the BizStep information objects are sequentially arranged into a plurality of functional blocks, and these functional blocks are connected according to the NS of the BizStep information objects (as shown in FIG. 9A).

In step S1403, the functional blocks are converted into corresponding subnet structures according to a process-to-Petri net conversion template (as shown in FIG. 9B).

Next, in step S1405, the corresponding input places and output places in the subnet structures are merged (as shown in FIG. 9C), and in step S1407, a Petri net-based supply chain network model is output.

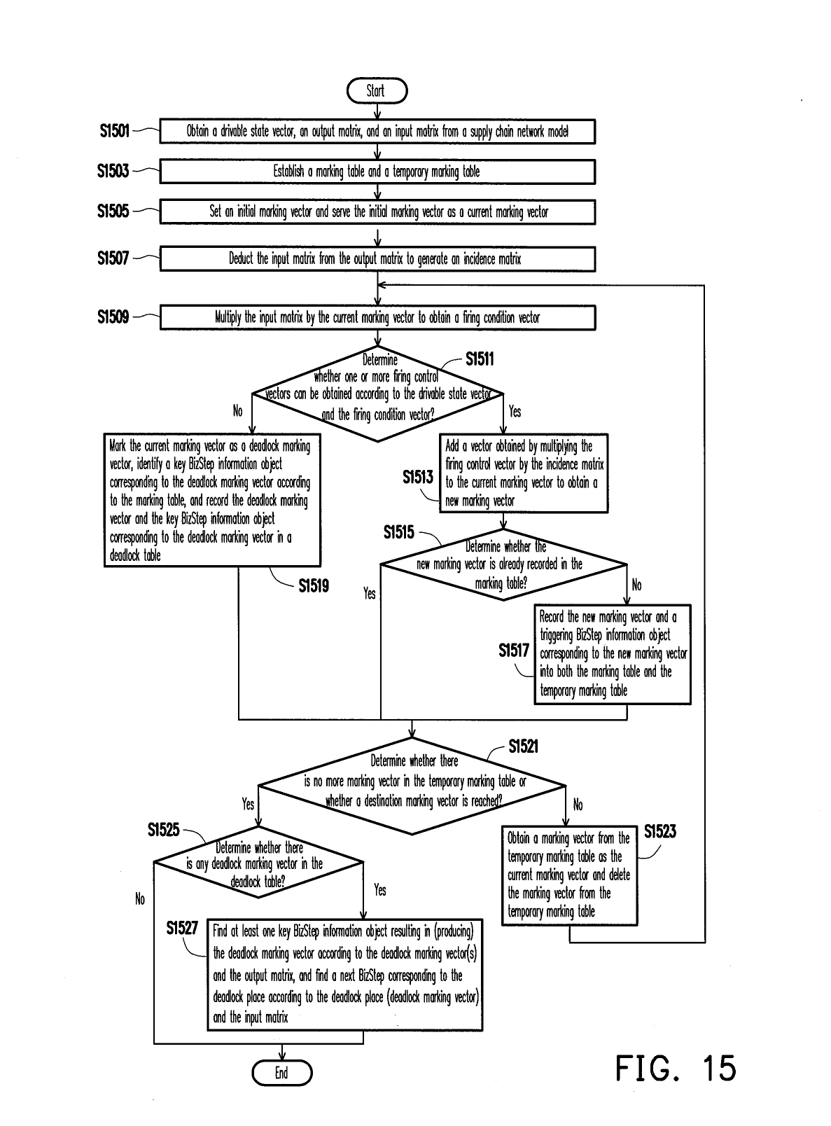

FIG. 15 is a flowchart of a deadlock diagnosis procedure according to an exemplary embodiment of the disclosure.

Referring to FIG. 15, in step S1501, the supply chain network model verification module 108 obtains a drivable state vector 1300, an output matrix 1400, and an input matrix 1500 from the supply chain network model 1100.

In step S1503, the supply chain network model verification module 108 establishes a marking table and a temporary marking table to record marking vectors during the activity process.

In step S1505, the supply chain network model verification module 108 sets an initial marking vector 1600 and serves the initial marking vector 1600 as a current marking vector.

In step S1507, the supply chain network model verification module 108 deducts the input matrix 1500 from the output matrix 1400 to generate an incidence matrix 1700. Steps S1501, S1503, S1505, and S1507 are referred to as initialization steps.

In step S1509, the supply chain network model verification module 108 multiplies the input matrix 1500 by the current marking vector 1800 to obtain a firing condition vector 1900.

In step S1511, the supply chain network model verification module 108 determines whether one or more firing control vectors can be obtained according to the drivable state vector 1300 and the firing condition vector 1900.

If the firing control vectors can be obtained, in step S1513, the supply chain network model verification module 108 adds the vector obtained by multiplying the firing control vector 2000 by the incidence matrix 1700 to the current marking vector 1800 to obtain a new marking vector 2100. Herein if multiple firing control vectors are obtained, the supply chain network model verification module 108 generates a new marking vector for each of the firing control vectors in step S1513.

Thereafter, in step S1515, the supply chain network model verification module 108 determines whether the new marking vector is already recorded in the marking table.

If the new marking vector is not recorded in the marking table yet, in step S1517, the supply chain network model verification module 108 records the new marking vector and a triggering BizStep information object corresponding to the new marking vector (i.e., the corresponding activity) into both the marking table and the temporary marking table. For example, the supply chain network model verification module 108 identifies the activity triggered by the new marking vector according to the output matrix 1400 and the input matrix 1500 of the supply chain network model 1100.

If no firing control vector is obtained, in step S1519, the supply chain network model verification module 108 marks the current marking vector 1800 as a deadlock marking vector, identifies the key BizStep information object corresponding to the deadlock marking vector (i.e., a corresponding activity) according to the marking table, and records the deadlock marking vector and the key BizStep information object corresponding to the deadlock marking vector in the deadlock table.

Thereafter, in step S1521, the supply chain network model verification module 108 determines whether there is no more marking vector in the temporary marking table or whether a destination marking vector is reached. Herein the destination marking vector is determined by the user.

If there are still marking vectors in the temporary marking table and the destination marking vector is not yet reached, in step S1523, the supply chain network model verification module 108 obtains a marking vector from the temporary marking table as the current marking vector and deletes the obtained marking vector from the temporary marking table. Thereafter, in step S1509, other nodes of the supply chain network model are further verified. The steps S1509, S15011, S1513, S1515, S1517, S1521, and S1523 are referred to as detection steps.

If there is no more marking vector in the temporary marking table or the destination marking vector is already reached, in step S1525, the supply chain network model verification module 108 determines whether there is any deadlock marking vector in the deadlock table.

If there are deadlock marking vectors in the deadlock table, in step S1527, the supply chain network model verification module 108 finds at least one key BizStep information object resulting in (producing) the deadlock marking vector according to the deadlock marking vector(s) and the output matrix, finds a next BizStep corresponding to the deadlock place according to the deadlock place (deadlock marking vector) and the input matrix, and highlights the deadlock place and related BizStep objects in the supply chain network object edit and management module 102. For example, the supply chain network model verification module 108 highlights the deadlock place and related BizStep information objects in the supply chain network model displayed in the edit and display interface 110. Steps S1525 and S1527 are referred to as deadlock confirmation steps.

In summary, the method and system for modeling a supply chain network provided by exemplary embodiments of the disclosure allow the upstream and downstream enterprises of a supply chain to successfully construct a supply chain network system based on a systematic platform. In particular, in an application of the “Internet of things”, the supply chain modelling method and system provided by exemplary embodiments of the disclosure can automatically define formats of event parameters and event templates for the corresponding supply chain events, so that an “Internet of things” system can be quickly established.

It will be apparent to those skilled in the art that various modifications and variations can be made to the structure of the disclosed embodiments without departing from the scope or spirit of the disclosure. In view of the foregoing, it is intended that the disclosure cover modifications and variations of this disclosure provided they fall within the scope of the following claims and their equivalents.

What is claimed is:

1. A method for modelling a supply chain network, comprising:
defining a plurality of pilot elements, wherein each of the pilot elements comprises a plurality of supply chain components;
receiving a plurality of user inputs;
generating and displaying a supply chain process according to the user inputs, wherein the supply chain process is constructed with the supply chain components of the pilot elements;
translating the supply chain process and generating a supply chain network model corresponding to the supply chain process; and
verifying the supply chain network model.

2. The method according to claim 1, wherein the step of generating and displaying the supply chain process according to the user inputs comprises:
defining at least one boundary of the supply chain process;
configuring a plurality of objects in the supply chain process, wherein each of the objects belongs to one of the supply chain components;
generating a material flow and an information flow of the supply chain process; and
identifying a plurality of supply chain event objects in the supply chain process.

3. The method according to claim 2, wherein the step of generating and displaying the supply chain process according to the user inputs further comprises:
configuring a plurality of radio-frequency identification (RFID) access points in the supply chain process; and
setting a tag filter pattern or an ontology rule in each of the RFID access points.

4. The method according to claim 2, wherein the objects comprise a plurality of business step (BizStep) information objects, a plurality of oval objects, a plurality of rectangular objects, a plurality of square objects, and a plurality of pentagonal objects, and the material flow and the information flow are constructed with the BizStep information objects,
wherein the step of configuring the objects in the supply chain process comprises:
identifying a next step pointer (NS) of each of the BizStep information objects;
identifying each of the oval objects as a location place;
identifying each of the rectangular objects as a status place;
identifying each of the square objects as a resource place; and
identifying each of the pentagonal objects as a kanban place.

5. The method according to claim 2, wherein the step of identifying the supply chain event objects in the supply chain process comprises:
generating an electronic product code information services (EPCIS) event parameter and an EPCIS event template for each of the supply chain event objects.

6. The method according to claim 4, wherein the step of translating the supply chain process and generating the supply chain network model corresponding to the supply chain process comprises:
categorizing and converting the BizStep information objects into a plurality of subnet structures by using a process-to-Petri net conversion template; and
converting the subnet structures into a Petri net-based supply chain network model.

7. The method according to claim 6, wherein the process-to-Petri net conversion template comprises a basic BizStep information object Petri net template, an advanced BizStep information object Petri net template, an OR-split BizStep information object Petri net template, a AND-split BizStep information object Petri net template, a OR-join BizStep information object Petri net template, a AND-join BizStep information object Petri net template, and a loop BizStep information object Petri net template.

8. The method according to claim 6, wherein the step of translating the supply chain process and generating the supply chain network model corresponding to the supply chain process further comprises:
identifying a token in the location place as a product, a product assembly, or a product part;
identifying a token in the resource place as a machine or a robot;
identifying a token in the status place as a processing status of a tagged object; and
identifying a token in the kanban place as a kanban information.

9. The method according to claim 4, wherein the step of translating the supply chain process and generating the supply chain network model corresponding to the supply chain process further comprises:
receiving at least one user tuning input; and
adjusting the Petri net-based supply chain network model according to the at least one user tuning input.

10. The method according to claim 6,
wherein the step of categorizing and converting the BizStep information objects into the subnet structures by using the process-to-Petri net conversion template comprises:
sequentially arranging the BizStep information objects into a plurality of functional blocks, and connecting the functional blocks according to the NS of the BizStep information objects; and
converting the functional blocks into the subnet structures according to the process-to-Petri net conversion template, wherein each of the subnet structures has at least one input place and at least one output place;
wherein the step of converting the subnet structures into the Petri net-based supply chain network model comprises:
merging corresponding input places and output places among the input places and the output places to connect the subnet structures; and
outputting the connected subnet structures as the Petri net-based supply chain network model.

11. The method according to claim 1, wherein the step of verifying the supply chain network model comprises:
verifying the supply chain network model by using a deadlock diagnosis procedure;
determining whether at least one deadlock place appears in the supply chain network model; and
when the at least one deadlock place appears in the supply chain network model, highlighting the at least one deadlock place in the supply chain network model.

12. The method according to claim 11, wherein the step of verifying the supply chain network model by using the deadlock diagnosis procedure comprises:
an initialization step, comprising:
obtaining a drivable state vector, an output matrix, and an input matrix from the supply chain network model;
establishing a marking table and a temporary marking table;
setting an initial marking vector and serving the initial marking vector as a current marking vector; and
deducting the input matrix from the output matrix to generate a incidence matrix;
a detection step, comprising:
a. multiplying the input matrix by the current marking vector to obtain a firing condition vector, and executing step b;
b. determining whether one or more firing control vectors are obtained according to the drivable state vector and the firing condition vector, wherein step c is executed when one or more firing control vectors are obtained, and step e is executed when no firing control vector is obtained;
c. respectively adding the current marking vector to one or more vectors obtained by multiplying the one or more firing control vectors by the incidence matrix to obtain one or more new marking vectors, and executing step d;
d. respectively determining whether the one or more new marking vectors are recorded in the marking table, wherein when the one or more new marking vectors are not recorded in the marking table, the new marking vectors and one or more triggering BizStep information objects corresponding to the one or more new marking vectors are recorded in both the marking table and the temporary marking table, and step f is executed;
e. marking the current marking vector as a deadlock marking vector, identifying a key BizStep information object corresponding to the deadlock marking vector according to the marking table, recording the deadlock marking vector and the key BizStep information object corresponding to the deadlock marking vector into a deadlock table, and executing step j;
f. determining whether there is no more marking vector in the temporary marking table or whether a destination marking vector is already reached, wherein when there are still marking vectors in the temporary marking table and the destination marking vector is not reached yet, step g is executed, and when there is no more marking vector in the temporary marking table or the destination marking vector is already reached, a deadlock confirmation step is executed;
g. obtaining a marking vector from the temporary marking table as the current marking vector, deleting the obtained marking vector in the temporary marking table, and executing step a,
wherein the deadlock confirmation step comprises:
determining whether there is any deadlock marking vector in the deadlock table; and
when there is at least one deadlock marking vector in the deadlock table, finding at least one key BizStep information object that results in the deadlock marking vector according to the deadlock marking vector and the output matrix, finding at least one related BizStep information object corresponding to the at least one deadlock place according to the deadlock marking vector and the input matrix, and highlighting the at least one deadlock place and the at least one related BizStep information object.

13. The method according to claim 1, wherein the step of defining the pilot elements comprises:
defining a people pilot element, a supply chain network information pilot element, a supply chain network location pilot element, a physical object pilot element, and a supply chain network event time pilot element.

14. A system for modelling a supply chain network, comprising:
a supply chain network object edit and management module, configured for defining a plurality of pilot elements, wherein each of the pilot elements comprises a plurality of supply chain components;
a supply chain process edit and management module, configured for receiving a plurality of user inputs and generating and displaying the supply chain process according to the user inputs, wherein the supply chain process is constructed with the supply chain components of the pilot elements;
a supply chain network translation and edit module, configured for translating the supply chain process and generating a supply chain network model corresponding to the supply chain process; and
a supply chain network model verification module, configured for verifying the supply chain network model.

15. The system according to claim 14, wherein the supply chain process edit and management module defines at least one boundary of the supply chain process according to the user inputs, configures a plurality of objects in the supply chain process, generates a material flow and an information flow of the supply chain process, and identifies a plurality of supply chain event objects in the supply chain process, wherein each of the objects belongs to one of the supply chain components.

16. The system according to claim 15, wherein the supply chain process edit and management module configures a plurality of RFID access points in the supply chain process according to the user inputs and sets a tag filter pattern or an ontology rule in each of the RFID access points.

17. The system according to claim 15, wherein the objects comprise a plurality of business step (BizStep) information objects, a plurality of oval objects, a plurality of rectangular objects, a plurality of square objects, and a plurality of pentagonal objects, and the material flow and the information flow are constructed with the BizStep information objects,
wherein the supply chain process edit and management module identifies a NS of each of the BizStep information objects, identifies each of the oval objects as a location place, identifies each of the rectangular objects as a status place, identifies each of the square objects as a resource place, and identifies each of the pentagonal objects as a kanban place.

18. The system according to claim 15, wherein the supply chain process edit and management module generates an EPCIS event parameter and an EPCIS event template for each of the supply chain event objects.

19. The system according to claim 17, wherein the supply chain network translation and edit module has a translating engine,
wherein the translating engine categorizes and converts the BizStep information objects into a plurality of subnet structures by using a process-to-Petri net conversion template,
wherein the translating engine converts the subnet structures into a Petri net-based supply chain network model.

20. The system according to claim 19, wherein the process-to-Petri net conversion template comprises a basic BizStep information object Petri net template, an advanced BizStep information object Petri net template, an OR-split BizStep information object Petri net template, an AND-split BizStep information object Petri net template, an OR-join BizStep information object Petri net template, an AND-join BizStep information object Petri net template, and a loop BizStep information object Petri net template.

21. The system according to claim 19,
wherein the supply chain network translation and edit module identifies a token in the location place as a product, a product assembly, or a product part,
wherein the supply chain network translation and edit module identifies a token in the resource place as a machine or a robot,
wherein the supply chain network translation and edit module identifies a token in the status place as a processing status of a tagged object,
wherein the supply chain network translation and edit module identifies a token in the kanban place as a kanban information.

22. The system according to claim 17, wherein the supply chain network translation and edit module receives at least one user tuning input and adjusts the Petri net-based supply chain network model according to the at least one user tuning input.

23. The system according to claim 19,
wherein the translating engine sequentially arranges the BizStep information objects into a plurality of functional blocks and connects the functional blocks according to the NS of the BizStep information objects,
wherein the translating engine converts the functional blocks into the subnet structures according to the process-to-Petri net conversion template, wherein each of the subnet structures has at least one input place and at least one output place,
wherein the translating engine merges corresponding input places and output places among the input places and the output places to connect the subnet structures,
wherein the translating engine outputs the connected subnet structures as the Petri net-based supply chain network model.

24. The system according to claim 14, wherein the supply chain network model verification module verifies the supply chain network model by using a deadlock diagnosis procedure.

25. The system according to claim 24, wherein the supply chain network model verification module determines whether at least one deadlock place appears in the supply chain network model,
wherein when the at least one deadlock place appears in the supply chain network model, the supply chain network model verification module highlights the at least one deadlock place in the supply chain network model.

26. The system according to claim 24,
wherein the supply chain network model verification module obtains a drivable state vector, an output matrix, and an input matrix from the supply chain network model;
wherein the supply chain network model verification module establishes a marking table and a temporary marking table;
wherein the supply chain network model verification module sets an initial marking vector and serves the initial marking vector as a current marking vector;
wherein the supply chain network model verification module deducts the input matrix from the output matrix to generate an incidence matrix;
wherein the supply chain network model verification module multiplies the input matrix by the current marking vector to obtain a firing condition vector,
wherein the supply chain network model verification module determines whether one or more firing control vectors are obtained according to the drivable state vector and the firing condition vector,
wherein when one or more firing control vectors are obtained, the supply chain network model verification module respectively adds the current marking vector to one or more vectors obtained by multiplying the one or more firing control vectors by the incidence matrix to obtain one or more new marking vectors and respectively determines whether the one or more new marking vectors are recorded in the marking table,
wherein when the one or more new marking vectors are not recorded in the marking table, the supply chain network model verification module records the one or more new marking vectors and one or more triggering BizStep information objects corresponding to the one or more new marking vectors into both the marking table and the temporary marking table,
wherein when no firing control vector is obtained, the supply chain network model verification module marks the current marking vector as a deadlock marking vector, identifies a key BizStep information object corresponding to the deadlock marking vector according to the marking table, and records the deadlock marking vector and the key BizStep information object corresponding to the deadlock marking vector into a deadlock table,
wherein the supply chain network model verification module determines whether there is no more marking vector in the temporary marking table or whether a destination marking vector is already reached,
wherein when there are still marking vectors in the temporary marking table and the destination marking vector is not reached yet, the supply chain network model verification module obtains another marking vector from the temporary marking table as the current marking vector and deletes the obtained marking vector from the temporary marking table,
when there is no more marking vector in the temporary marking table or the destination marking vector is already reached, the supply chain network model verification module determines whether there is any deadlock marking vector in the deadlock table,
wherein when there is at least one deadlock marking vector in the deadlock table, the supply chain network model verification module finds the key BizStep information object corresponding to the at least one deadlock place according to the deadlock marking vector and the output matrix, finds at least one related BizStep information object corresponding to the at least one deadlock place according to the deadlock marking vector and the input matrix, and highlights the deadlock place and the related BizStep information object.

27. The system according to claim 14, wherein the pilot elements comprise a people pilot element, a supply chain network information pilot element, a supply chain network location pilot element, a physical object pilot element, and a supply chain network event time pilot element.
